(19) United States
(12) Patent Application Publication
(10) Pub. No.: US 2023/0237839 A1
(43) Pub. Date: Jul. 27, 2023

(54) INFORMATION PROCESSING APPARATUS, INFORMATION PROCESSING METHOD, AND NON-TRANSITORY COMPUTER READABLE MEDIUM

(71) Applicant: TOYOTA JIDOSHA KABUSHIKI KAISHA, Toyota-shi (JP)

(72) Inventor: Tatsuro HORI, Tokyo-to (JP)

(73) Assignee: TOYOTA JIDOSHA KABUSHIKI KAISHA, Toyota-shi (JP)

(21) Appl. No.: 18/157,441

(22) Filed: Jan. 20, 2023

(30) Foreign Application Priority Data
Jan. 25, 2022 (JP) 2022-009692

(51) Int. Cl. G06V 40/16

(52) U.S. Cl. CPC G06V 40/168; G06V 40/166

(57) ABSTRACT

An information processing apparatus includes a controller configured to generate an avatar of a user as a 3D object based on a user image of the user. The controller is configured to acquire a new image of the user, generate an excluded image by excluding a portion from the new image, and update the avatar of the user by rendering the excluded image in overlap with at least a portion of the user image.

### CROSS-REFERENCE TO RELATED APPLICATION

This application claims priority to Japanese Patent Application No. 2022-9692, filed on Jan. 25, 2022, the entire contents of which are incorporated herein by reference.

### TECHNICAL FIELD

The present disclosure relates to an information processing apparatus, an information processing method, and a non-transitory computer readable medium.

### BACKGROUND

Methods for generating avatars using images of users are known. For example, see Patent Literature (PTL) 1.

### Citation List

### Patent Literature

PTL 1: JP 2020-119156 A

### SUMMARY

In a case of generating an avatar based on an image of a user, the image might contain information that the user does not wish to have reflected in the avatar. Demand exists for generating an avatar in such a way that unnecessary information is not reflected.

It would be helpful to generate an avatar in such a way that unnecessary information is not reflected.

An information processing apparatus according to an embodiment of the present disclosure includes a controller configured to generate an avatar of a user as a 3D object based on a user image of the user. The controller is configured to acquire a new image of the user, generate an excluded image by excluding a portion from the new image, and update the avatar of the user by rendering the excluded image in overlap with at least a portion of the user image.

An information processing method according to an embodiment of the present disclosure includes generating an avatar of a user as a 3D object based on a user image of the user. The information processing method includes acquiring a new image of the user. The information processing method includes generating an excluded image by excluding a portion from the new image. The information processing method includes updating the avatar of the user by rendering the excluded image in overlap with at least a portion of the user image.

A non-transitory computer readable medium according to an embodiment of the present disclosure stores an information processing program. The information processing program causes an information processing apparatus to generate an avatar of a user as a 3D object based on a user image of the user. The information processing program causes the information processing apparatus to acquire a new image of the user. The information processing program causes the information processing apparatus to generate an excluded image by excluding a portion from the new image. The information processing program causes the information processing apparatus to update the avatar of the user by rendering the excluded image in overlap with at least a portion of the user image.

According to an information processing apparatus, an information processing method, and a non-transitory computer readable medium in embodiments of the present disclosure, an avatar can be generated in such a way that unnecessary information is not reflected.

### BRIEF DESCRIPTION OF THE DRAWINGS

In the accompanying drawings:

FIG. 1 is a block diagram illustrating an example configuration of an information processing system according to an embodiment;

FIG. 2 is a diagram illustrating examples of front, left, and right side user images;

FIG. 3 is a diagram illustrating an example of an image yielded by combining the user images in FIG. 2;

FIG. 4 is a diagram illustrating an example of a 3D object yielded by pasting the composite image in FIG. 3 on a surface;

FIG. 5 is a diagram illustrating an example of a new user image;

FIG. 6 is a diagram illustrating an example of the new user image of FIG. 5 in overlap with the composite image of FIG. 3;

FIG. 7 is a diagram illustrating an example of an excluded image by excluding a portion of the new user image;

FIG. 8 is a diagram illustrating an example of the excluded image of FIG. 7 in overlap with the composite image of FIG. 3; and

FIG. 9 is a flowchart illustrating an example procedure for an information processing method according to an embodiment.

### DETAILED DESCRIPTION

### Configuration of Information Processing System 1

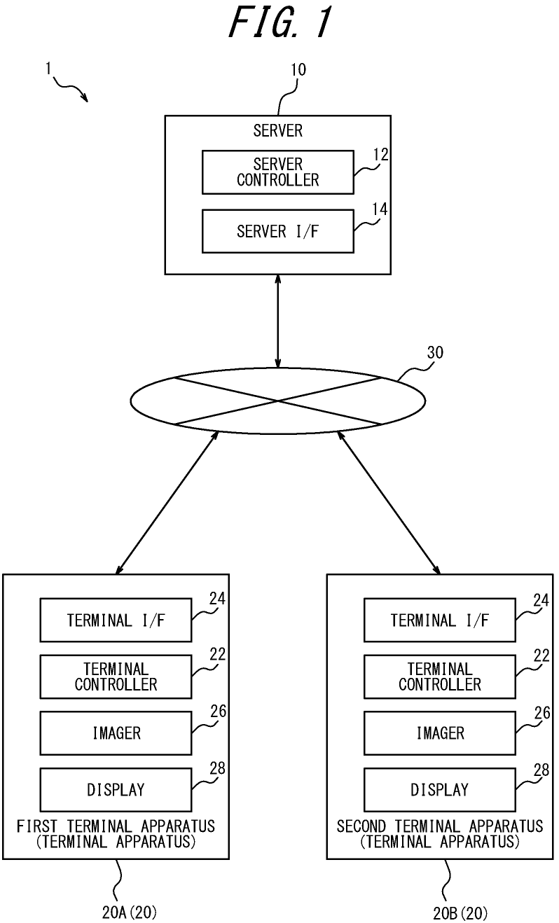

As illustrated in FIG. 1, an information processing system 1 according to an embodiment includes a server 10 and terminal apparatuses 20. The terminal apparatuses 20 are presumed to be in the possession of users. The terminal apparatuses 20 are presumed to include a first terminal apparatus 20A. The first terminal apparatus 20A is presumed to be in the possession of a first user. While not essential, the terminal apparatuses 20 may include a second terminal apparatus 20B. The first terminal apparatus 20B is presumed to be in the possession of a second user. The server 10 and the terminal apparatuses 20 are presumed to be connected in a wired or wireless manner so as to communicate with each other via a network 30. The server 10 and the terminal apparatuses 20 may be connected to each other communicably by wired or wireless communication that does not involve the network 30.

The information processing system 1 is configured to generate an avatar of a user based on a captured image of the user. A captured image of a user is also referred to as a user image. The user image may include an RGB image or a depth image of the user. A configuration of the information processing system 1 is described below.

### <Server 10>

The server 10 includes a server controller 12 and a server interface 14. The server interface 14 is also referred to as a server I/F 14.

The server controller 12 controls at least one component of the server 10. The server controller 12 may be configured with at least one processor. The “processor” is a general purpose processor, a dedicated processor specialized for specific processing, or the like in the present embodiment but is not limited to these. The server controller 12 may be configured with at least one dedicated circuit. The dedicated circuit may include, for example, a field-programmable gate array (FPGA) or an application specific integrated circuit (ASIC). The server controller 12 may be configured with a dedicated circuit instead of a processor, or may be configured with a dedicated circuit along with a processor.

The server 10 may further include a memory. The memory is a semiconductor memory, a magnetic memory, an optical memory, or the like, for example, but not limited to these. The memory may function, for example, as a main memory, an auxiliary memory, or a cache memory. The memory may include an electromagnetic storage medium, such as a magnetic disk. The memory may include a non-transitory computer readable medium. The memory may store any information used for operations of the server 10. For example, the memory may store a system program, an application program, or the like. The memory may be included in the server controller 12.

Information, data, or the like is outputted from and inputted to the server controller 12, through the server I/F 14. The server I/F 14 may include a communication module for communication with other apparatuses, such as the terminal apparatuses 20, via a network 30. The communication module may, for example, be compliant with a mobile communication standard such as the 4th Generation (4G) standard or the 5th Generation (5G) standard. The communication module may be compliant with a communication standard such as a Local Area Network (LAN). The communication module may be compliant with a wired or wireless communication standard. The communication module is not limited to these examples and may be compliant with various communication standards. The server I/F 14 may be configured to be connected to the communication module.

The server I/F 14 may be configured with an input device for receiving inputs, such as information or data, from a user. The input device may be configured with, for example, a touch panel, a touch sensor, or a pointing device such as a mouse. The input device may be configured with a physical key. The input device may be configured with an audio input device, such as a microphone.

The server I/F 14 may be configured with an output device that outputs information, data, or the like to the user. The output device may include, for example, a display device that outputs visual information, such as images, letters, or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with a light emitting device, such as a Light Emitting Diode (LED) or a Laser Diode (LD). The display device may be configured with various other devices. The output device may include, for example, a speaker or other such audio output device that outputs audio information, such as voice. The output device is not limited to the above examples and may include various other devices.

The server 10 may include a single server apparatus, or multiple server apparatuses capable of communicating with each other.

### <Terminal Apparatus 20>

The terminal apparatus 20 includes a terminal controller 22 and a terminal I/F 24. The terminal apparatus 20 may be configured with one or more processors or one or more dedicated circuits. The terminal apparatus 20 may be further configured with a memory. The memory of the terminal apparatus 20 may be configured to be identical or similar to the memory of the server 10.

The terminal I/F 24 may be configured with a communication module. The terminal I/F 24 may be configured to be identical or similar to the server I/F 14.

The terminal I/F 24 may be configured with an input device for receiving inputs, such as information or data, from a user. The input device may be configured with the various devices described as the server I/F 14.

While not essential, the terminal apparatus 20 may further include an imager 26. The imager 26 may include a camera or other imaging device that captures RGB images. The imager 26 may include a depth sensor that acquires depth images or a ranging device such as a stereo camera. The terminal apparatus 20 may acquire user images via the terminal I/F 24 from an external imaging device or ranging device. The terminal I/F 24 may include the functions of an imaging device or a ranging device.

While not essential, the terminal apparatus 20 may further include a display 28. The display 28 may be configured to display a virtual 3D space including the avatar of the user. The display 28 may be configured with the variety of display devices, such as an LCD, that were illustrated as configurations of the server I/F 14. The terminal I/F 24 may include the functions of the display 28.

The number of terminal apparatuses 20 included in the information processing system 1 is not limited to one and may be two or more. The terminal apparatus 20 may be configured by a mobile terminal, such as a smartphone or a tablet, or a Personal Computer (PC), such as a notebook PC or a tablet PC. The terminal apparatus 20 is not limited to the above examples and may include various devices.

### Operation Example of Information Processing System 1

In the information processing system 1 according to the present embodiment, the server 10 and/or terminal apparatus 20 may generate or update the avatar of the user. The server 10 or terminal apparatus 20 that generates the avatar of the user is also collectively referred to as an information processing apparatus. Hereafter, the server controller 12 of the server 10 or the terminal controller 22 of the terminal apparatus 20 is simply referred to as the controller. The server I/F 14 of the server 10 or the terminal I/F 24 of the terminal apparatus 20 is simply referred to as the I/F. An operation example in which the information processing apparatus generates and updates an avatar is described below.

### <Avatar Generation>

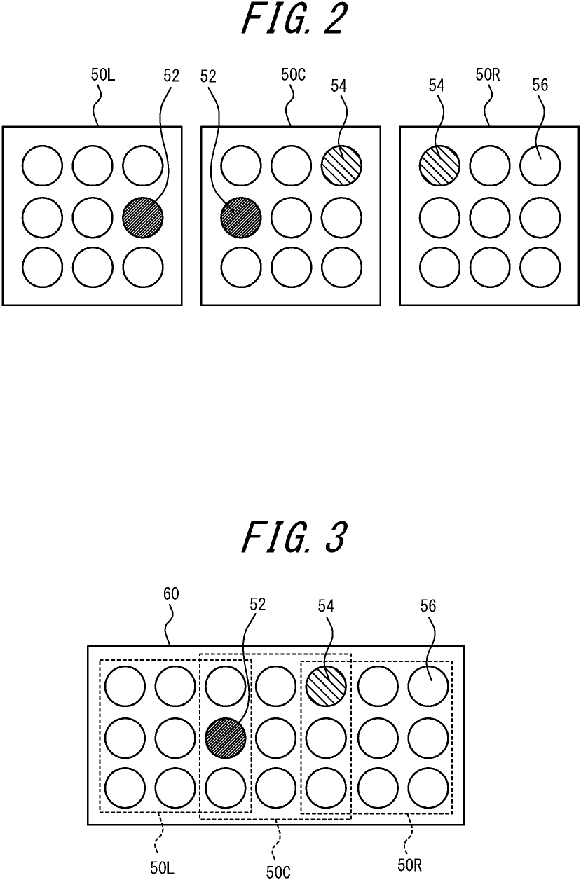

The controller acquires a captured image of the user as a user image. The controller may acquire images of the user captured from at least two directions as user images. As illustrated in FIG. 2, the controller may acquire a partial image 50L of the user captured from the left side, a partial image 50C of the user captured from the front, and a partial image 50R of the user captured from the right side as user images. In the present embodiment, the controller acquires both an RGB image and a depth image of the user as user images. The images illustrated in FIG. 2 may be RGB images or depth images. The controller may acquire only RGB images as user images. The controller may output instructions to the user, via the terminal I/F 24 or display 28 of the terminal apparatus 20 in the user’s possession, to operate the imager 26 of the terminal apparatus 20 and capture images of the user himself or herself from at least two directions. The controller may output instructions to the user to move so as to adjust the orientation of the user relative to a camera or a distance measurement sensor of an external apparatus, so that the user is captured from at least two directions by the camera or the distance measurement sensor.

It is presumed that both the partial image 50L and the partial image 50C include a first landmark 52 representing a feature of the user’s appearance. It is also presumed that both the partial image 50C and the partial image 50R include a second landmark 54 representing a feature of the user’s appearance. The first landmark 52 and the second landmark 54 may, for example, correspond to feature points on the user’s face, such as the user’s eyes, nose, mouth, or ears. The first landmark 52 and the second landmark 54 may, for example, correspond to feature points on the user’s body, such as the user’s hands, feet, head, neck, or torso. The first landmark 52 and the second landmark 54 are also referred to simply as landmarks. A portion of the user image that is not considered a feature of the user’s appearance is usually referred to as a point 56. The controller may acquire information about features of the user’s appearance, such as the first landmark 52 and second landmark 54, along with the user images. The controller may detect features of the user’s appearance, such as the first landmark 52 and second landmark 54, from the user images.

The controller can generate the composite image 60 illustrated in FIG. 3 by combining the partial image 50L with the partial image 50C based on the position of the first landmark 52 and combining the partial image 50C with the partial image 50R based on the position of the second landmark 54. The composite image 60 is an image combining the partial image 50L, the partial image 50C, and the partial image 50R. The composite image 60 is used to generate the avatar of the user. The composite image 60 may include an image combining RGB images of the user or an image combining depth images of the user. The composite image 60 may be generated as an image combining an RGB image and a depth image of the user.

As the position at which a feature of the user, such as the first landmark 52 and the second landmark 54, is detected in the user image is closer to the edge of the user image, the area of the overlapping region when two user images are combined is smaller. As the area of the overlapping region is smaller, the area of the composite image 60 can be expanded. The controller may acquire the user images so that features of the user, such as the first landmark 52 and the second landmark 54, are detected near the edges of the user image. For example, the controller may output instructions to the user to move so that the features of the user appear close to the edges of the user image when a user image is acquired. When acquiring two or more user images, the controller may output instructions to the user to move so that a common feature appears in each of at least two user images.

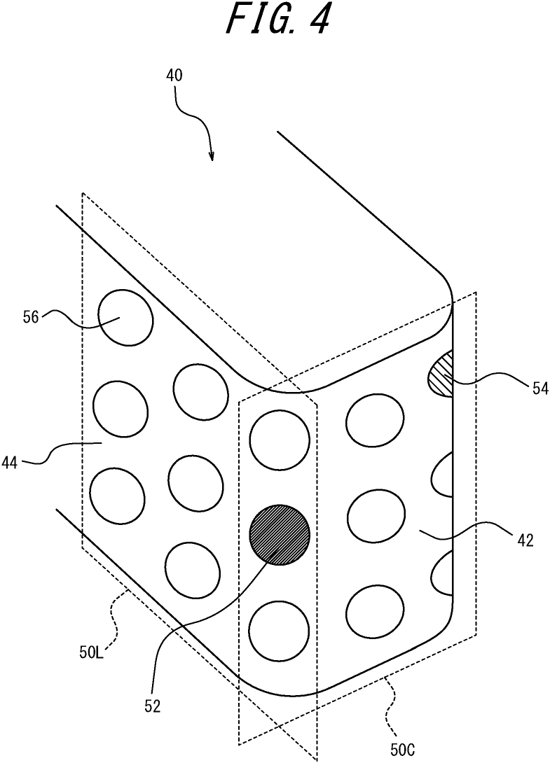

The controller may generate the avatar of the user as a 3D object 40 by rendering (pasting) the composite image 60 on the outer surface of the 3D object 40, as illustrated in FIG. 4. The 3D object 40 illustrated in FIG. 4 has a front 42 and a side 44. It is presumed that the front 42 and the side 44 are connected by a curved surface. The controller renders the portion of the left side partial image 50L in the composite image 60 on the side 44 of the 3D object 40. The controller renders the portion of the front partial image 50C in the composite image 60 on the front 42 of the 3D object 40. In this case, the overlapping portion of the partial image 50L and the partial image 50C in the composite image 60 is rendered on the curved surface connecting the front 42 and side 44 of the 3D object 40.

In the example in FIG. 4, the composite image 60 is rendered along the outer surface of the 3D object 40. In a case in which the composite image 60 includes a depth image, the controller may reflect the irregularities, identified by the depth image, in the shape of the outer surface of the 3D object 40.

In a case in which a single image of the user captured from one direction is acquired as the user image, the controller may generate an avatar by rendering the single image along the outer surface of the 3D object 40.

The shape of the outer surface of the 3D object 40 is not limited to a prismatic shape with rounded corners as illustrated in FIG. 4 but may be various shapes represented by various planar or curved surfaces. The shape of the outer surface of the 3D object 40 may, for example, include an elliptical surface or be a combination of a plurality of solids.

In the composite image 60 illustrated in FIG. 3 and FIG. 4, the first landmark 52, second landmark 54, and the normal point 56 are spaced apart. The composite image 60 may be configured so that the first landmark 52, the second landmark 54, and the normal point 56 are connected. When rendering the composite image 60 on the outer surface of the 3D object 40, the controller may render the first landmark 52, the second landmark 54, and the normal point 56 so as to be connected. The controller may render the area between the first landmark 52, the second landmark 54, and the normal point 56 based on a pre-defined user skin color or the like.

As described above, an avatar of a user can be generated based on a user image in the information processing system 1. The server 10 may generate the avatar based on user images acquired by the terminal apparatus 20 or may generate the avatar based on user images acquired by an external apparatus. The first terminal apparatus 20A may generate an avatar based on user images acquired by the second terminal apparatus 20B or may generate an avatar based on user images acquired by the first terminal apparatus 20A itself. Conversely, the second terminal apparatus 20B may generate an avatar based on user images acquired by the first terminal apparatus 20A or may generate an avatar based on user images acquired by the second terminal apparatus 20B itself.

### <Avatar Display>

In a case in which the server 10 has generated an avatar, the server 10 may output information on the avatar to the terminal apparatus 20 for the display 28 of the terminal apparatus 20 to display the avatar. In a case in which the terminal apparatus 20 has generated an avatar, the terminal apparatus 20 may display the avatar on its own display 28 and may output information on the avatar to another terminal apparatus 20 for the display 28 of the other terminal apparatus 20 to display the avatar.

The terminal controller 22 of the terminal apparatus 20 may display the avatars in a virtual 3D space. The avatars may be configured as an object that can be rotatably displayed in the virtual 3D space.

The avatar is not limited to the terminal apparatus 20 and may also be displayed on an external display apparatus.

### <Avatar Update>

The controller acquires a new user image 70, as illustrated in FIG. 5. The new user image 70 may include images captured from the same direction as the partial images 50L, 50C, 50R, or the like used to generate the avatar or may include images captured from a different direction. The controller acquires information about features of the user’s appearance, such as the first landmark 52 or the second landmark 54, included in the new user image 70. In FIG. 5, it is assumed that the new user image 70 includes the first landmark 52. The controller may acquire information about the features of the user’s appearance included in the new user image 70 along with the new user image 70. The controller may detect features of the user’s appearance from the new user image 70. A portion of the new user image 70 that is not considered a feature of the user’s appearance is usually referred to as a point 76.

In a case in which a feature of the user’s appearance, such as the first landmark 52 or the second landmark 54, included in the composite image 60 that is already used for the avatar is also included in the new user image 70, the controller may update the composite image 60 based on the position of the feature. Specifically, the controller may update the composite image 60 by rendering (overwriting) the new user image 70 in overlap with the composite image 60 so that the feature included in the composite image 60 and the feature included in the new user image 70 overlap.

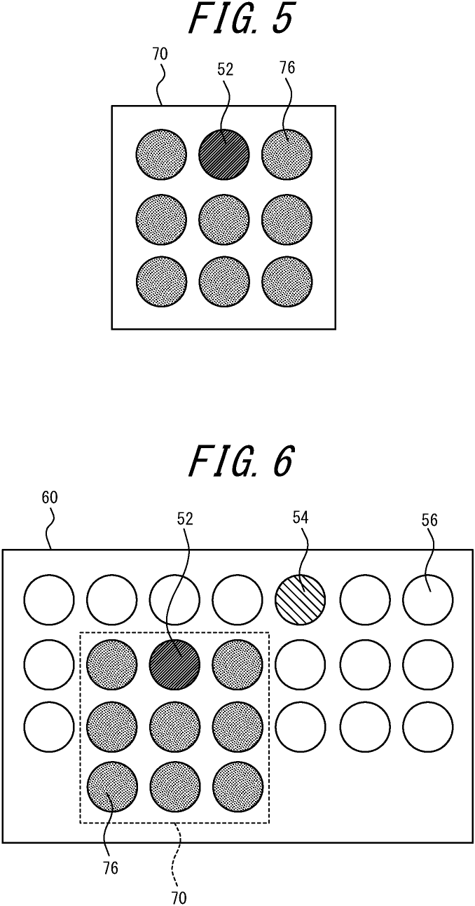

The controller may render the new user image 70 in overlap with the composite image 60 so that the position of the first landmark 52 in the composite image 60 matches the position of the first landmark 52 in the new user image 70, as illustrated in FIG. 6, for example. In this case, the new user image 70 is rendered to protrude below the composite image 60. The controller may update the composite image 60 as an extended image with a portion protruding beyond the original composite image 60. The composite image 60 may be updated as an image from which the portion protruding from the original composite image 60 is removed.

Users may not want a portion of the information in the new user image 70 to be reflected in the avatar. Users may, for example, not want changes in their hairstyle, or changes in the area below the neck, such as their clothing, to be reflected in the avatar. The controller may update the composite image 60 by excluding portions of the new user image 70 that are not to be reflected in the avatar.

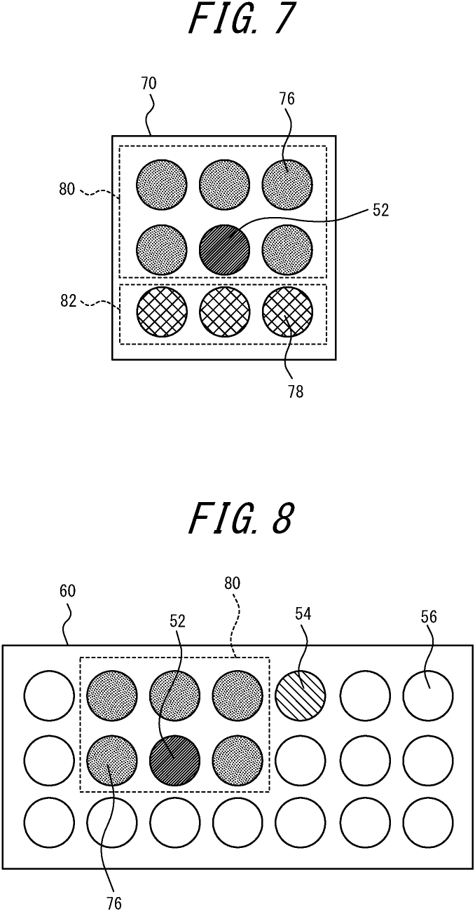

The controller recognizes a portion of the new user image 70 that the user does not want reflected in the avatar as an excluded range 82, as illustrated in FIG. 7, for example. The points included in the excluded range 82 are referred to as excluded points 78. The controller generates an excluded image 80 by excluding the excluded range 82 from the new user image 70. In the user image 70 in FIG. 7, it is assumed that the first landmark 52 is the user’s neck. In this case, the excluded range 82 reflects the user’s desire not to have changes in the area below the neck reflected in the avatar.

The controller may update the composite image 60 using the excluded image 80, for example, as illustrated in FIG. 8. The controller may render the excluded image 80 in overlap with the composite image 60 so that the position of the first landmark 52 in the excluded image 80 matches the position of the first landmark 52 in the composite image 60. In this way, the composite image 60 is not updated in areas that the user did not want reflected in the avatar.

The controller may identify the excluded range 82 based on information specified by the user. The controller may identify the excluded range 82 based on a body part specified by the user. The controller may also identify the excluded range 82 based on features of the user. Specifically, the controller may receive input specifying features of the user that serve as criteria for identifying the excluded range 82. The controller may, for example, accept input of information that, with the user’s neck as a reference, specifies the area below the neck (such as clothing) as the excluded range 82. The controller may, for example, accept input from the user of information that, with the user’s eyes as a reference, specifies the area above the eyes (such as hairstyle) as the excluded range 82. The controller may identify the excluded range 82 based on a color specified by the user. The controller may detect the user’s body frame from the user image and identify the excluded range 82 based on the body frame detection results.

As described above, the avatar of the user can be updated based on a new user image 70 in the information processing system 1. The server 10 may update the avatar based on a user image 70 acquired by the terminal apparatus 20 or may update the avatar based on a user image 70 acquired by an external apparatus. The first terminal apparatus 20A may update the avatar based on a user image 70 acquired by the second terminal apparatus 20B or may update the avatar based on a user image 70 acquired by the first terminal apparatus 20A itself. Conversely, the second terminal apparatus 20B may update the avatar based on a user image 70 acquired by the first terminal apparatus 20A or may update the avatar based on a user image 70 acquired by the second terminal apparatus 20B itself.

The avatar update may be performed by the same apparatus that originally generated the avatar, or by a different apparatus. For example, an avatar initially generated by the server 10 may be updated by the server 10 or by the terminal apparatus 20. An avatar initially generated by the first terminal apparatus 20A may be updated by the first terminal apparatus 20A, by the server 10, or by the second terminal apparatus 20B.

The updated avatar may be displayed on the display 28 of the terminal apparatus 20 in the same or a similar manner as when first generated, or the updated avatar may be displayed on an external display apparatus.

### <Example Procedure for Information Processing Method>

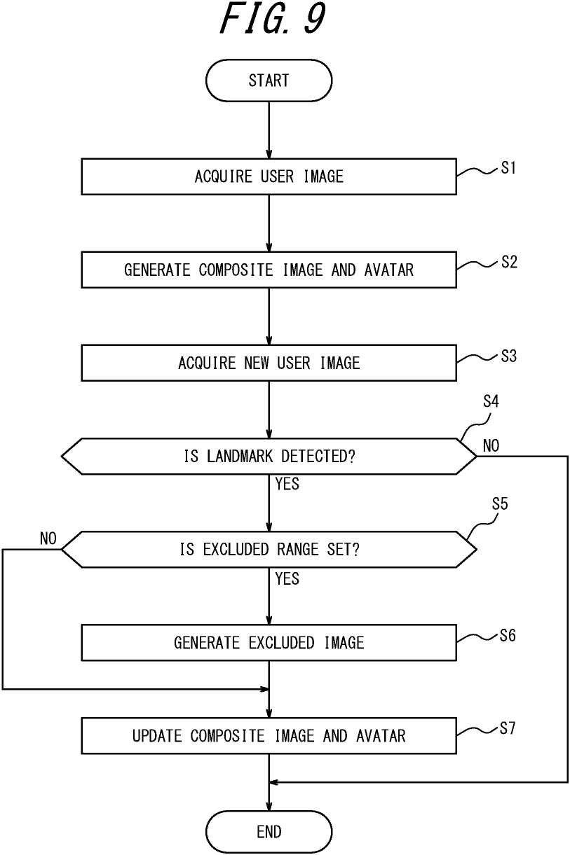

As described above, in the information processing system 1 according to the present embodiment, an information processing apparatus including the server 10 or the terminal apparatus 20 generates a user avatar as a 3D object 40 based on a user image. The controller of the information processing apparatus may perform an information processing method including the procedures of the flowchart in FIG. 9, for example. The information processing method may be implemented as an information processing program to be executed by the controller of the information processing apparatus. The information processing program may be stored on a non-transitory computer readable medium.

The controller acquires a user image (step S1). The controller generates a composite image 60 and an avatar as a 3D object 40 (step S2). The controller acquires a new user image 70 (step S3).

The controller determines whether a landmark can be detected in the new user image 70 (step S4). In other words, the controller determines whether the new user image 70 includes a landmark. In a case in which a landmark cannot be detected in the new user image 70 (step S4: NO), the controller terminates the flowchart procedures in FIG. 9 without updating the composite image 60 with the new user image 70.

In a case in which a landmark can be detected in the new user image 70 (step S4: YES), the controller determines whether an excluded range 82 is set in the new user image 70 (step S5). Specifically, the controller may determine that an excluded range 82 is set in a case in which the controller receives an input from the user specifying a portion that the user does not want reflected in the avatar or in a case in which the controller acquires information setting the excluded range 82. Conversely, the controller may determine that the excluded range 82 is not set in a case in which the controller has not received an input from the user specifying a portion that the user does not want reflected in the avatar and the controller has not acquired information setting the excluded range 82.

In a case in which the excluded range 82 is not set (step S5: NO), the controller proceeds to step S7. In a case in which the excluded range 82 is set (step S5: YES), the controller generates an image that excludes the excluded range 82 from the new user image 70 as an excluded image 80 (step S6). The controller updates the composite image 60 and avatar based on the new user image 70 or the excluded image 80 (step S7). Specifically, in a case in which the excluded image 80 is generated, the controller updates the composite image 60 with the excluded image 80 and updates the avatar by rendering the outer surface of the 3D object 40 with the updated composite image 60. In a case in which the excluded image 80 has not been generated, the controller updates the composite image 60 with the new user image 70 and updates the avatar by rendering the outer surface of the 3D object 40 with the updated composite image 60. After performing the procedure of step S7, the controller terminates the procedures of the flowchart in FIG. 9.

### <Summary>

As described above, according to the information processing system 1, the server 10, the terminal apparatus 20, and the information processing method of the present embodiment, an avatar is generated based on a user image. Information specified by the user is excluded from the information to be reflected in the avatar when the avatar is updated based on the new user image 70. In this way, avatars are generated in such a way that unnecessary information is not reflected. The user’s demands are thus fulfilled.

### Other Embodiments

In a case in which a plurality of applications display avatars, the controller of the information processing apparatus may coordinate with each application to generate avatars separately in the manner used by each application. The controller may identify a user image required to generate an avatar for a user logged into each application on the terminal apparatus 20. For example, the controller may determine that an image captured from the side or back of the user is required. The controller may determine that an image of the user’s face is required. The controller may determine that an image of the user’s entire body is required.

The controller may guide the operations of the terminal apparatus 20 by the user so that the required user image can be acquired by the terminal apparatus 20. For example, the controller may specify the direction from which an image of the user is to be captured by the terminal apparatus 20. The controller may specify the range for the terminal apparatus 20 to capture an image of the user. The controller may specify a part of the user’s body to be captured by the terminal apparatus 20. The controller may guide user operations so that potential landmarks are captured.

The terminal controller 22 of the terminal apparatus 20 may execute application software to acquire user images. The application software for acquiring user images is also referred to as a photography application. The photography application may be linked to applications that display an avatar.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An information processing apparatus comprising a controller configured to generate an avatar of a user as a 3D object based on a user image of the user, wherein
the controller is configured to
acquire a new image of the user,
generate an excluded image by excluding a portion from the new image, and
update the avatar of the user by rendering the excluded image in overlap with at least a portion of the user image.

2. The information processing apparatus according to claim 1, wherein the controller is configured to receive input from the user specifying a portion to be excluded from the new image, and generate the excluded image based on the input received from the user.

3. The information processing apparatus according to claim 1, wherein the controller is configured to acquire a plurality of partial images of the user captured from a plurality of directions and generate the user image by connecting each partial image.

4. The information processing apparatus according to claim 2, wherein the controller is configured to acquire a plurality of partial images of the user captured from a plurality of directions and generate the user image by connecting each partial image.

5. The information processing apparatus according to claim 1, wherein the controller is configured to detect a feature of the user included in common in the user image and the new image, generate the excluded image based on the feature of the user, and render the excluded image in overlap with at least a portion of the user image so that the feature of the user overlaps between the user image and the excluded image.

6. The information processing apparatus according to claim 2, wherein the controller is configured to detect a feature of the user included in common in the user image and the new image, generate the excluded image based on the feature of the user, and render the excluded image in overlap with at least a portion of the user image so that the feature of the user overlaps between the user image and the excluded image.

7. The information processing apparatus according to claim 3, wherein the controller is configured to detect a feature of the user included in common in the user image and the new image, generate the excluded image based on the feature of the user, and render the excluded image in overlap with at least a portion of the user image so that the feature of the user overlaps between the user image and the excluded image.

8. The information processing apparatus according to claim 4, wherein the controller is configured to detect a feature of the user included in common in the user image and the new image, generate the excluded image based on the feature of the user, and render the excluded image in overlap with at least a portion of the user image so that the feature of the user overlaps between the user image and the excluded image.

9. An information processing method for generating an avatar of a user as a 3D object based on a user image of the user, the information processing method comprising:
acquiring a new image of the user;
generating an excluded image by excluding a portion from the new image; and
updating the avatar of the user by rendering the excluded image in overlap with at least a portion of the user image.

10. A non-transitory computer readable medium storing an information processing program for causing an information processing apparatus to generate an avatar of a user as a 3D object based on a user image of the user, the information processing program causing the information processing apparatus to perform operations comprising:
acquiring a new image of the user;
generating an excluded image by excluding a portion from the new image; and
updating the avatar of the user by rendering the excluded image in overlap with at least a portion of the user image.
